(19) United States
(12) Patent Application Publication
(10) Pub. No.: US 2009/0213952 A1
(43) Pub. Date: Aug. 27, 2009

(54) METHOD FOR DEINTERLEAVING OFDM SIGNALS AND APPARATUS USING THE SAME

(75) Inventors: SHIH YI YEH, Hsinchu County (TW); JIA CHING LEE, Hsinchu County (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, Hsinchu County (TW)

(21) Appl. No.: 12/335,856

(22) Filed: Dec. 16, 2008

(30) Foreign Application Priority Data
Feb. 21, 2008 (TW) 097106029

(51) Int. Cl. H04L 27/28

(52) U.S. Cl. 375/260

(57) ABSTRACT

An apparatus for deinterleaving OFDM signals comprises a block deinterleaving memory, a computing module, a processed-tone buffer and a subcarrier rotator. The block deinterleaving memory is configured to store unprocessed symbols of the OFDM signals. The computing module is configured to access the block deinterleaving memory in accordance with the order of a first interleaving action for the OFDM signals and to compute thereafter. The processed-tone buffer is configured to store processed symbols of the OFDM signals. The subcarrier rotator is configured to access the processed-tone buffer and to perform a second interleaving action for the OFDM signals.

### BACKGROUND OF THE INVENTION

1. Field of the Invention

The present invention relates to a deinterleaving apparatus and method, and more particularly, to a deinterleaving apparatus and method applying orthogonal frequency division multiplexing (OFDM).

2. Description of the Related Art

OFDM is a transmission method that uses multiple orthogonal frequencies to transmit signals, and is widely used as a primary transmission technology according to the Institute of Electrical and Electronics Engineers (IEEE) 802.11 standard. An OFDM apparatus transforms a plurality of signals in frequency domain into time domain and lengthens the signal time so as to reduce the inter-symbol interference (ISI) effect caused by multiple paths. Also, the plurality of orthogonal signal transmissions can deal with the inter-carrier interference (ICI) problem. In addition, the transformation between time domain and frequency domain is conducted by Fast Fourier Transform (FFT) so as to use existing hardware to implement the design.

An OFDM apparatus in a transmitter conducts a modulation to the signals in frequency domain first, and then transforms the modulated signals into time domain signals by an FFT operation. Before the transformation, the OFDM apparatus conducts two interleaving actions, which are defined by IEEE 802.11a as follow:

i=(N_{CBPS}/16)(k mod 16)+floor(k/16)

j=s×floor(i/s)+(i+N_{CBPS}−floor(16×i/N_{CBPS}))mod s

s=max(N_{BPSC}/2,1)

where k represents an index of a bit of the OFDM signals before the first interleaving action, i represents an index of the bit of the OFDM signals before the first interleaving action, j represents an index of the bit of the OFDM signals before the second interleaving action, N_{CBPS} represents the number of bits after encoding of the OFDM signals, N_{BPSC} represents the number of bits after encoding of the sub-carriers, mod represents a modulus operation, floor represents a maximum integer after the operations in the bracket, max represents the maximum among parameters in the bracket.

The first interleaving step, as shown in FIG. 1, is performed by writing data row-wise, and reading the data column-wise, dispersing bits b0 to b63 of an OFDM symbol. If error correction codes of the OFDM apparatus are used simultaneously, some subcarrier defects or overlarge noises can be avoided. Since the interleaving action is done in a block-to-block manner, the action is called “block interleaving.” The second interleaving step performs a new permutation on neighboring s signals, which uniformly distributes bits between the most significant bit (MSB) and least significant bit (LSB) in the constellation so as to avoid duplicate bits for LSB.

FIG. 2 shows a block diagram of an OFDM deinterleaver in a conventional receiver. The deinterleaver 20 receives signals from an FFT transformer 25, and outputs deinterleaved signals to a decoder 26. The block diagram comprises a block deinterleaving memory 21, a frequency compensation rotator 22, a space time block coding (STBC) rotator 23 and a subcarrier rotator (SCR) or a soft metric generator (SMG) 24. The OFDM signals form frequency domain symbols through the FFT transformer 25, and then the frequency domain symbols are stored in the block deinterleaving memory 21. If the OFDM signals comply with the 802.11a standard and their N_{CBPS} is 192, then their N_{BPSC} is

$$\frac{192}{48} = 4 ,$$

and thus b0, b16, b32 and b48 form an unprocessed symbol S₀. If the deinterleaving action for b0 is intended, the symbol S₀ must go through the processes of the frequency compensation rotator 22 and the STBC rotator 23, and the subcarrier rotator 24 retrieves b0 in accordance with the second interleaving formula and then transmits the same to a decoder 26 such as Viterbi decoder. If the deinterleaving action for b 16 is intended, the symbol S₀ must still go through the processes of the frequency compensation rotator 22 and the STBC rotator 23, and the subcarrier rotator 24 retrieves b16. Because the block deinterleaving memory 21 has to be accessed and the frequency compensation rotator 22 and the STBC rotator 23 have to be computed once if any bit is processed, the power consumption of the deinterleaver 20 is excessive.

To effectively resolve the foregoing problem, it is necessary to develop a novel deinterleaving method and apparatus so as to reduce the number of accesses for the block deinterleaving memory 21 and the computing operations of the frequency compensation rotator 22 and the STBC rotator 23 so as to reduce the power consumption of the deinterleaver 20.

### SUMMARY OF THE INVENTION

An apparatus for deinterleaving orthogonal frequency division multiplexing (OFDM) signals in accordance with one embodiment of the present invention comprises a block deinterleaving memory, a computing module, a processed-tone buffer and a subcarrier rotator. The block deinterleaving memory is configured to store unprocessed symbols of the OFDM signals. The computing module is configured to access the block deinterleaving memory in accordance with the order of a first interleaving action for the OFDM signals and to compute thereafter. The processed-tone buffer is configured to store processed symbols of the OFDM signals. The subcarrier rotator is configured to access the processed-tone buffer and to perform a second interleaving action for the OFDM signals.

A method for deinterleaving OFDM signals in accordance with one embodiment of the present invention comprises the steps of: receiving unprocessed OFDM signals in a frequency domain and storing the unprocessed OFDM signals into a block deinterleaving memory; accessing symbols of the OFDM signals in a direction perpendicular to a direction in which the unprocessed OFDM signals are stored into the block deinterleaving memory; processing symbols of the accessed OFDM signals; storing one row of the processed symbols into a processed-tone buffer; and deinterleaving bits of the processed symbols in the processed-tone buffer.

A method for deinterleaving OFDM signals in accordance with one embodiment of the present invention comprises the steps of: receiving unprocessed OFDM signals in a frequency domain and storing the unprocessed OFDM signals into a block deinterleaving memory; accessing the OFDM signals from the block deinterleaving memory, wherein any symbol of the OFDM signals is accessed only once; processing symbols of the OFDM signals and then storing the processed symbols in a processed-tone buffer; and deinterleaving the processed symbols in the processed-tone buffer, wherein the number of deinterleaving actions for each symbol of the OFDM signals is equal to the number of bits of the symbol.

### BRIEF DESCRIPTION OF THE DRAWINGS

The invention will be described according to the appended drawings in which:

FIG. 1 shows a hint diagram of the first interleaving and deinterleaving methods applying to OFDM signals;

FIG. 2 shows a block diagram of an OFDM deinterleaver in a conventional receiver;

FIG. 3 shows a block diagram of a deinterleaver applied to OFDM signals in accordance with one embodiment of the present invention; and

FIG. 4 shows a flow chart of an OFDM signal deinterleaving method in accordance with one embodiment of the present invention.

### PREFERRED EMBODIMENT OF THE PRESENT INVENTION

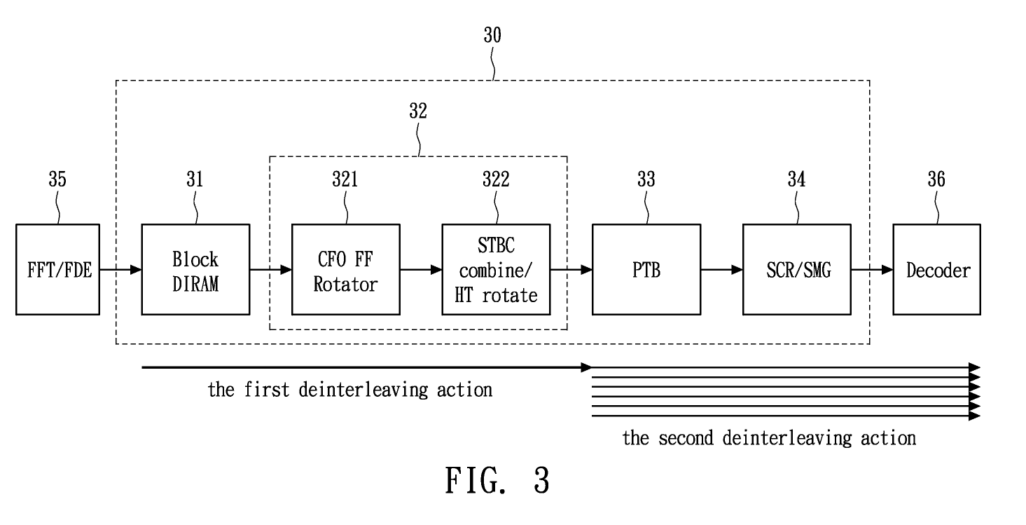

FIG. 3 shows a block diagram of a deinterleaver applied to OFDM signals in accordance with one embodiment of the present invention. The deinterleaver 30 includes a block deinterleaving memory 31, a computing module 32, a processed-tone buffer 33 and a subcarrier rotator 34. The block deinterleaving memory 31 receives and stores OFDM signals from an FFT transformer 35. The computing module 32 accesses symbols of the OFDM signals from the block deinterleaving memory 31 in accordance with a first deinterleaving order of the OFDM signals, and then duly processes them. The computing module 32 includes a frequency compensation rotator 321 and an STBC rotator 322, where the frequency compensation rotator 321 is used to compensate the frequency offset of symbols of the OFDM signals, and the STBC rotator 322 is used to demodulate symbols of the OFDM signals. After the processed-tone buffer 33 stores the processed symbols from the computing module 32, the subcarrier rotator 34 accesses stored symbols in the processed-tone buffer 33 so as to perform the second deinterleaving action.

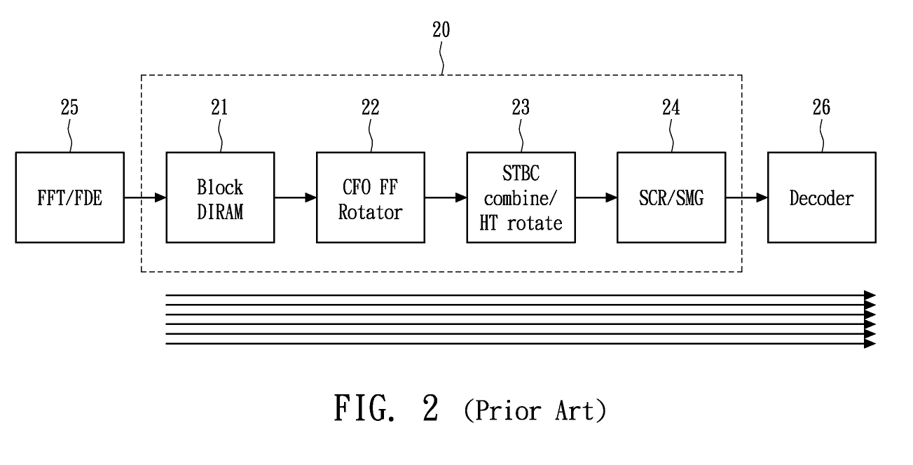

As shown in FIG. 3, the symbols of the OFDM signals are only accessed once by the block deinterleaving memory 31 and calculated once by the computing module 32, and then stored in the processed-tone buffer 33. Subsequently, the subcarrier rotator 34 accesses bits of the processed symbols of the OFDM signals through the processed-tone buffer 33 to perform the second deinterleaving action without repeatedly going through the block deinterleaving memory 31 and the computing module 32. For example, if the N_{BPSC} of the OFDM signals is six, then the block deinterleaving memory 31 and the computing module 32 perform one access and operation action upon any subcarrier symbol of the OFDM signals, and the processed-tone buffer 33 and the subcarrier rotator 34 perform six access and operation actions upon any processed subcarrier symbol. Compared to the conventional deinterleaver 20 shown in FIG. 2, the conventional block deinterleaving memory 21, frequency compensation rotator 22 and STBC rotator 23 perform six access and operation actions upon any subcarrier symbol, and the subcarrier rotator 24 performs six operation actions upon any processed subcarrier symbol. The apparatus 30 of the present invention reduces the number of access and operation actions upon the block deinterleaving memory 31 and the computing module 32, and thus effectively reduces the necessary power consumption. In fact, for an OFDM signal whose N_{BPSC} is equal to 6, 4 and 2, the power consumption of the deinterleaver 30 of the present invention is one sixth, one fourth and one half, respectively, of the power consumption of the conventional deinterleaver 20. In addition, the lower access number represents that the block deinterleaving memory 31 requires a smaller bandwidth, and thus the hardware structure of the block deinterleaving memory 31 can be implemented in a simpler and more efficient manner. As such, the advantages of reduced power consumption and lower cost can be achieved.

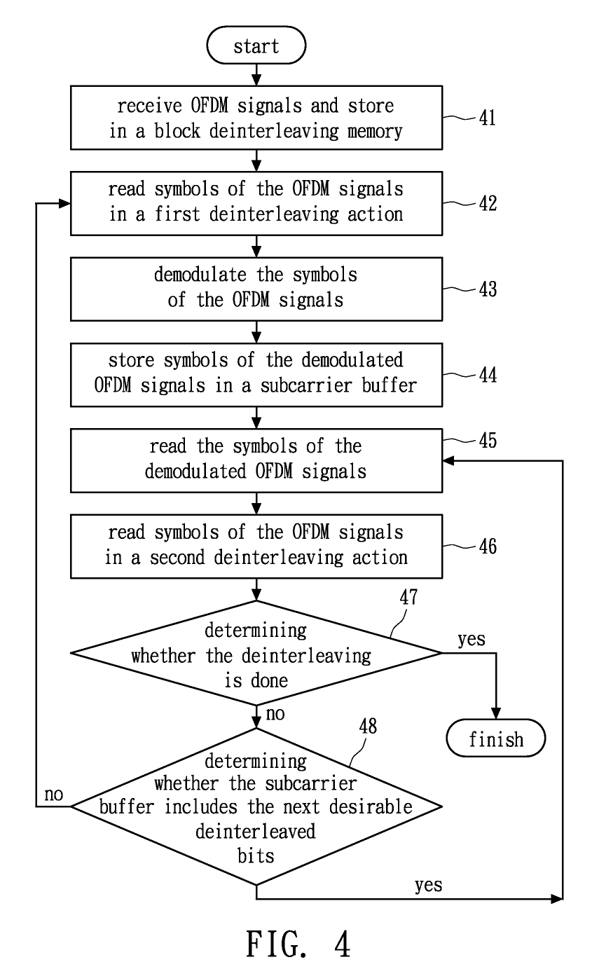

FIG. 4 shows a flow chart of the OFDM signal deinterleaving method in accordance with one embodiment of the present invention. In Step 41, unprocessed frequency domain OFDM signals are stored in a block deinterleaving memory 31. In Step 42, in accordance with the first OFDM signal deinterleaving formula, the symbols of the OFDM signals are accessed in another direction perpendicular to the direction of storing the symbols of the OFDM signals into the block deinterleaving memory 31, and the symbol is expressed as {S₀,S₁, . . . ,S₁₅}. In Step 43, the accessed symbols of the OFDM signals are processed, and are expressed as {Ŝ₀,Ŝ₁, . . . ,Ŝ₁₅}. In Step 44, one row of the processed symbols are stored into a processed-tone buffer 33. Because the processed-tone buffer 33 is used to separate the subcarrier tone process and bit process, and only results relevant to the symbol process need to be stored, the necessary capacity is far less than the capacity of the block deinterleaving memory 31. Normally, the capacity of the processed-tone buffer 33 is smaller than one tenth of the block deinterleaving memory 31. Preferably, for a typical IEEE 802.11n modem, the capacity of the processed-tone buffer 33 is about one eighteenth of the block deinterleaving memory 31. In Step 45, the symbols stored in the processed-tone buffer 33 are accessed. In Step 46, the second deinterleaving action is performed for the accessed symbols in accordance with the second OFDM signal deinterleaving formula. In Step 47, it is determined whether the OFDM signals have been deinterleaved. If the answer is affirmative, the flow ends; otherwise, Step 48 is performed. In Step 48, it is determined whether the next operative OFDM symbol is stored in the processed-tone buffer 33. If the answer is affirmative, the flow goes to Step 45 to access the processed-tone buffer 33 again. Otherwise, the flow goes to Step 42 to access OFDM symbols stored in the block deinterleaving memory 31 again and continues the deinterleaving operation.

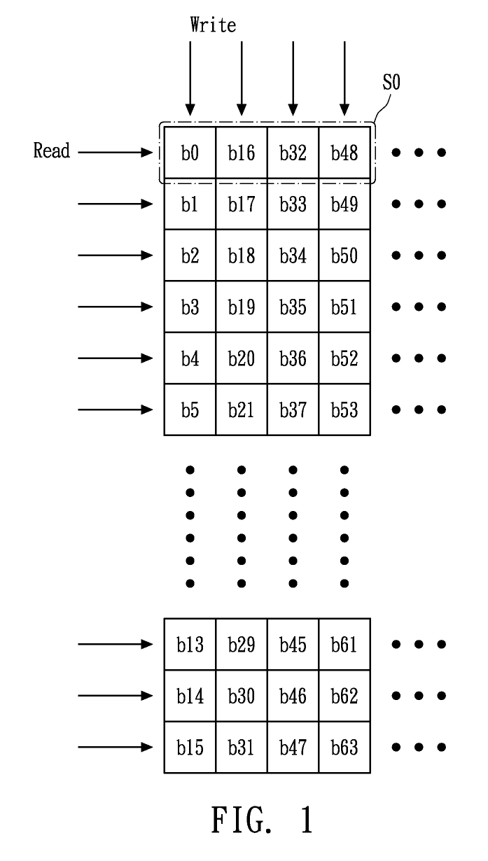

Corresponding to the OFDM signals shown in FIG. 1, in Step 41, the signals are stored into the block deinterleaving memory 31 column-wise. The first deinterleaving bit is b0, and in Step 42, the subcarrier symbols S₀ are accessed. After the demodulation process is performed in Step 43, in Step 44 the processed symbols S₀ are stored in a processed-tone buffer 33. In Step 45, the symbol S₀ is accessed, and b0 is obtained through Step 46. In Step 47, if the OFDM signal deinterleaving action has not been completed, Step 48 is performed. In Step 48, the next operative deinterleaving bit is b1, and if it is not inside the processed-tone buffer 33, the flow goes back to Step 42 to access the next symbol. If the next operative deinterleaving bit is b16, which is stored in the processed-tone buffer 33, the flow goes back to Step 45 to access the next bit.

Compared to the conventional deinterleaving method, the present invention moves a large part of operations between Steps 42 and 44 to Steps 45 and 46, and thus reduces the operations between Steps 42 and 44 as well as reducing a significant amount of hardware power consumption.

The above-described embodiments of the present invention are intended to be illustrative only. Numerous alternative embodiments may be devised by persons skilled in the art without departing from the scope of the following claims.

What is claimed is:

1. An apparatus for deinterleaving orthogonal frequency division multiplexing (OFDM) signals, comprising:
a block deinterleaving memory configured to store unprocessed symbols of the OFDM signals;
a computing module configured to access the block deinterleaving memory in accordance with an order of a first interleaving action for the OFDM signals and to compute thereafter;
a processed-tone buffer configured to store processed symbols of the OFDM signals; and
a subcarrier rotator configured to access the processed-tone buffer and to perform a second interleaving action for the OFDM signals.

2. The apparatus of claim 1, wherein the computing module comprises a frequency compensation rotator and a space time block coding (STBC) rotator, wherein the frequency compensation rotator is configured to compensate a frequency offset of the symbols of the OFDM signals, and the STBC rotator is configured to demodulate the symbols of the OFDM signals.

3. The apparatus of claim 1, wherein the OFDM signals are written into the block deinterleaving memory column-wise, and are accessed row-wise.

4. The apparatus of claim 1, wherein the OFDM signals are written into the block deinterleaving memory row-wise, and are accessed column-wise.

5. The apparatus of claim 1, wherein any unprocessed symbol in the block deinterleaving memory is accessed only once.

6. The apparatus of claim 1, wherein any unprocessed symbol of the OFDM signals is processed only once by the computing module.

7. The apparatus of claim 1, wherein the number of accesses of any processed symbol in the processed-tone buffer is equal to the number of bits of the processed symbol.

8. The apparatus of claim 1, wherein the capacity of the processed-tone buffer is smaller than one tenth of the capacity of the block deinterleaving memory.

9. The apparatus of claim 1, which complies with Institute of Electrical and Electronics Engineers (IEEE) 802.11 standards.

10. A method for deinterleaving orthogonal frequency division multiplexing (OFDM) signals, comprising the steps of:
receiving unprocessed OFDM signals in a frequency domain and storing the unprocessed OFDM signals into a block deinterleaving memory;
accessing symbols of the OFDM signals in a direction perpendicular to a direction in which the unprocessed OFDM signals are stored into the block deinterleaving memory;
processing symbols of the accessed OFDM signals;
storing the processed symbols into a processed-tone buffer; and
deinterleaving bits of the processed symbols in the processed-tone buffer.

11. The method of claim 10, wherein any symbol of the OFDM signals is accessed from the block deinterleaving memory only once.

12. The method of claim 10, wherein any symbol of the OFDM signals is processed only once.

13. The method of claim 10, wherein the number of deinterleaving actions is equal to the number of bits of the processed symbol.

14. The method of claim 10, which complies with Institute of Electrical and Electronics Engineers (IEEE) 802.11 standards.

15. The method of claim 10, further comprising the step of continuously accessing symbols in the processed-tone buffer if the processed-tone buffer comprises the next operative deinterleaving bit.

16. The method of claim 10, further comprising the step of accessing symbols of the next OFDM signal in the block deinterleaving memory if the processed-tone buffer does not include the next operative deinterleaving bit.

17. A method for deinterleaving orthogonal frequency division multiplexing (OFDM) signals, comprising the steps of:
receiving unprocessed OFDM signals in a frequency domain and storing the unprocessed OFDM signals into a block deinterleaving memory;
accessing the OFDM signals from the block deinterleaving memory, wherein any symbol of the OFDM signals is accessed only once;
processing symbols of the OFDM signals and then storing the processed symbols in a processed-tone buffer; and
deinterleaving the processed symbols in the processed-tone buffer, wherein the number of deinterleaving actions for symbols of the OFDM signals is equal to the number of bits of the symbols.

18. The method of claim 17, further comprising the step of accessing symbols of the OFDM signals in a direction perpendicular to a direction in which the unprocessed OFDM signals are stored into the block deinterleaving memory.

19. The method of claim 17, wherein the capacity of the processed-tone buffer is smaller than one tenth of the capacity of the block deinterleaving memory.

20. The method of claim 17, which complies with the IEEE 802.11 standard.
